(19) United States
(12) Patent Application Publication
(10) Pub. No.: US 2014/0231414 A1
(43) Pub. Date: Aug. 21, 2014

(54) MAGNETIC HEAT GENERATION AND TRANSFER APPARATUS AND METHOD

(71) Applicant: ROBERT LYNN NELSON, CUDJOE KEY, FL (US)

(72) Inventor: ROBERT LYNN NELSON, CUDJOE KEY, FL (US)

(21) Appl. No.: 14/269,252

(22) Filed: May 5, 2014

(51) Int. Cl. H05B 6/02

(52) U.S. Cl. CPC H05B 6/02
USPC 219/628

(57) ABSTRACT

A magnetic heat generation and transfer apparatus and method for generating transferable usable heat. The magnetic heat generation and transfer apparatus and method includes a base; an air mover assembly mounted to the base and including a power source with a rotatable drive shaft and also including disc members spaced apart and attached to the rotatable shaft; and a heat generating assembly mounted to the base and including pivotable elongate support members and magnetic members attached to the elongate support members for generating eddy currents resulting in heat generation.

### BACKGROUND OF THE INVENTION

1. Field of the Invention

The present invention relates to heat generators and more particularly pertains to a new magnetic heat generation and transfer apparatus and method for generating transferable usable heat.

2. Description of the Prior Art

The use of heat generators is known in the prior art. More specifically, heat generators heretofore devised and utilized are known to consist basically of familiar, expected and obvious structural configurations, notwithstanding the myriad of designs encompassed by the crowded prior art which have been developed for the fulfillment of countless objectives and requirements.

The prior art includes a magnetic heater having a conductor assembly and a magnet assembly. The magnet assembly is adapted to rotate relative to the conductor assembly about an axis so as to induce eddy currents in the conductor assembly when relative motion is produced between the conductor assembly and first magnet assembly. The conductor assembly defines a fluid path therein for the transfer of heat from the conductor assembly to a fluid. The magnetic heater is a component of a heat generation system comprising an internal combustion engine having a drive shaft for rotating the magnet assembly. The heat generated by the magnetic heater, as well as the beat generated by the engine from the engine exhaust and engine cooling system, is combined to heat a fluid. Another prior includes a magnetic heater having a conductive member and a first magnet assembly comprising a frame and at least one magnet disposed a distance adjacent the conductive member, wherein the first magnet assembly and the first frame are adapted to rotate relative to each other about an axis so as to induce eddy currents in the conductive member when relative motion is produced between the conductive member and the first magnet assembly, the at least one magnet adapted to move relative to the frame in dependence on the change in the rate of rotation of the frame. The magnetic heater is provided with a passive relative-positioning actuator adapted to move one or more magnets in an axial direction and a radial direction relative to the frame. Such movement is exploited to control the magnetic field strength at the conductive member by controlling, among other things, the conductor/magnet spacing. While these devices fulfill their respective, particular objectives and requirements, the aforementioned patents do not disclose a new magnetic heat generation and transfer apparatus and method.

### SUMMARY OF THE INVENTION

The general purpose of the present invention, which will be described subsequently in greater detail, is to provide a new magnetic heat generation and transfer apparatus and method which, has many of the advantages of the heat generators mentioned heretofore and many novel features that result in a new magnetic heat generation and transfer apparatus and method which is not anticipated, rendered obvious, suggested, or even implied by any of the prior art heat generators, either alone or in any combination thereof. The present invention includes a base; an air mover assembly mounted to the base and Including a power source with a rotatable drive shaft and also including disc members spaced apart and attached to the rotatable shaft; and a heat generating assembly mounted to the base and including pivotable elongate support members and hi agnatic members attached to the elongate support members for generating eddy currents resulting in heat generation. None of the prior art includes the combination of the elements of the present invention.

There has thus been outlined, rather broadly, the more important features of the magnetic heat generation and transfer apparatus and method in order that the detailed description thereof that follows may he better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the assembles of the components set forth in the following description or illustrated in the drawings. The invention is capable of other embodiments and of being practiced and carried out in various ways. Also, it is to be understood that the phraseology and terminology employed herein are fox the purpose of description and should not be regarded as limiting.

It is an object of the present invention to provide a new magnetic heat generation and transfer apparatus and method which has many of the advantages of the heat generators mentioned heretofore and many novel features that result in a new magnetic heat generation and transfer apparatus and method which is not anticipated, rendered obvious, suggested, or even implied by any of the prior art heat generators, either alone or in any combination thereof.

Still another object of the present invention is to provide a new magnetic heat generation and transfer apparatus and method for generating transferable usable heat.

Still yet another object of the present invention is to provide a new magnetic beat generation and transfer apparatus and method that is monitored with sensors and a fan is used to transfer the generated heat through conduits.

Even still another object of the present invention is to provide a new magnetic heal generation and transfer apparatus and method that automatically controls the spacing of the magnets to the conductors to effectuate maximum efficient heat.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than these set forth above will become apparent when consideration is given to the following detailed description thereof. Such description makes reference to the annexed drawings wherein;

FIG. 1 is a perspective view of a new magnetic heat generation and transfer apparatus according to the present invention.

FIG. 2 is another perspective view of the present invention.

FIG. 3 is an end cross sectional view of the present invention.

FIG. 4 is a side elevation view of the present invention.

FIG. 5 is a block diagram of the method of using the present invention

### DETAILED DESCRIPTION OF THE INVENTION

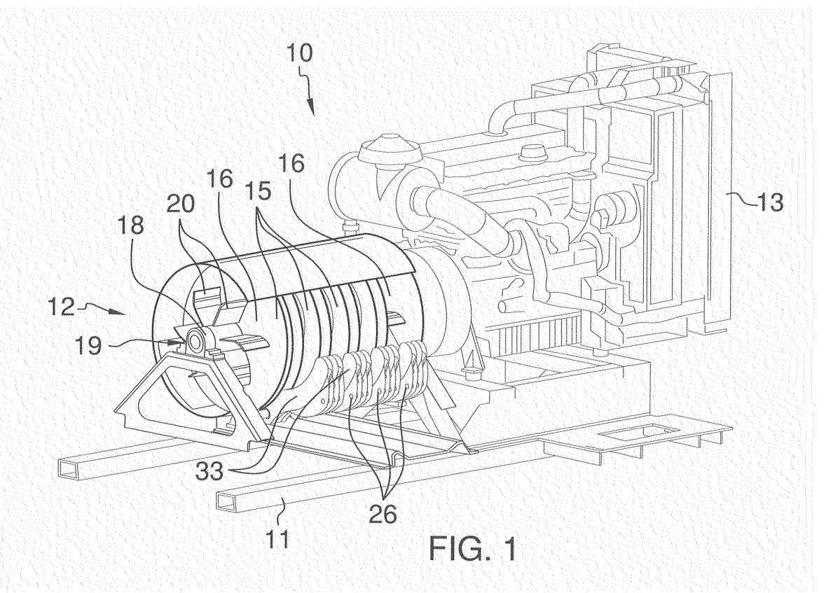

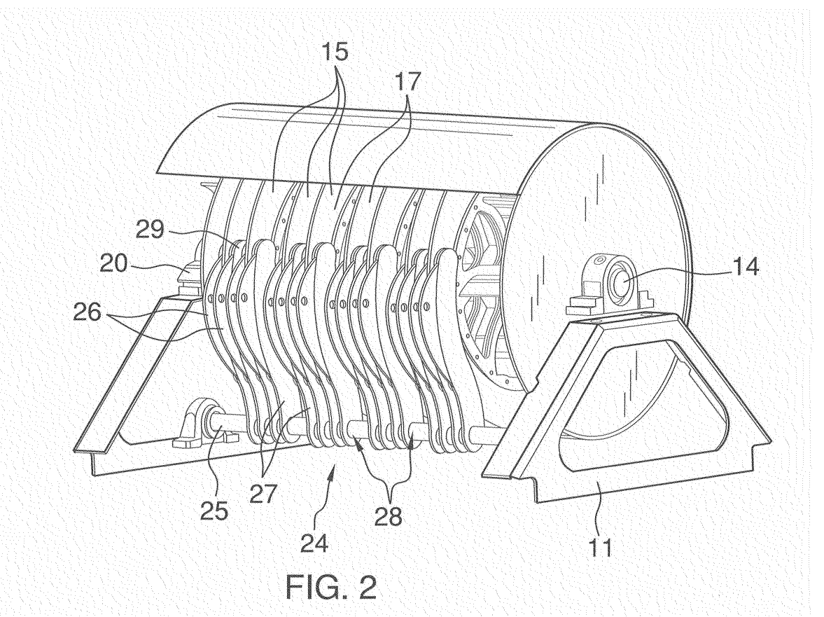

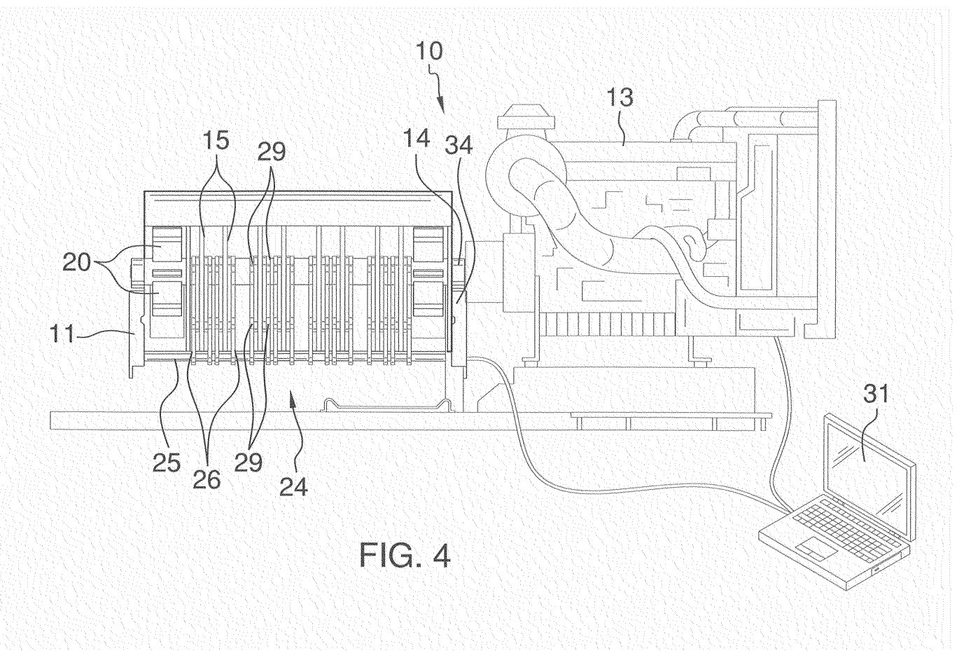

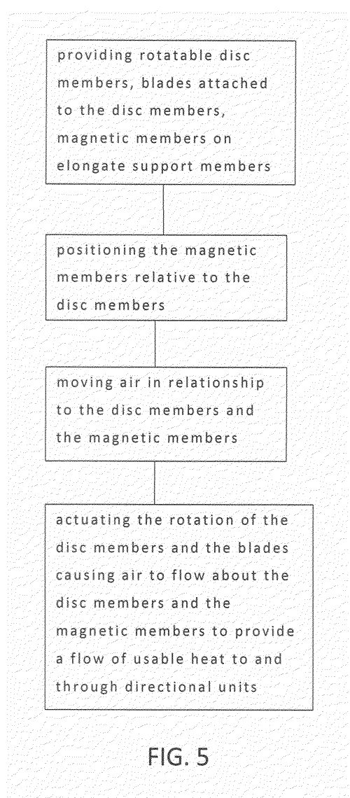

With reference now to the drawings, and in particular to FIGS. 1 through 5 thereof, a new magnetic heat generation and transfer apparatus and method embodying the principles and concepts of the present invention and generally designated by the reference numeral 10 will be described.

As best illustrated in FIGS. 1 through 5, the magnetic heat generation and transfer apparatus and method 10 may generally comprise a base it; an air mover assembly 12 conventionally mounted to the base 11 and including a power source 13 with a rotatable drive shaft 14 and also including disc members 15 spaced apart and conventionally attached to the rotatable drive shaft 14; and a heat generating assembly 24 conventionally mounted to the base 11 and including pivotable elongate support members 26 and magnetic members 29 conventionally attached to the elongate support members 26 for generating eddy currents resulting in heat generation. The magnetic members 29 may be blocks of magnets having selective sizes and shapes and are spaced along the lengths of the elongate support members 26 with the elongate support members 26 having opposed planar sides 32, 33 with the magnetic members 29 conventionally spaced and attached, upon the opposed sides 32, 33.

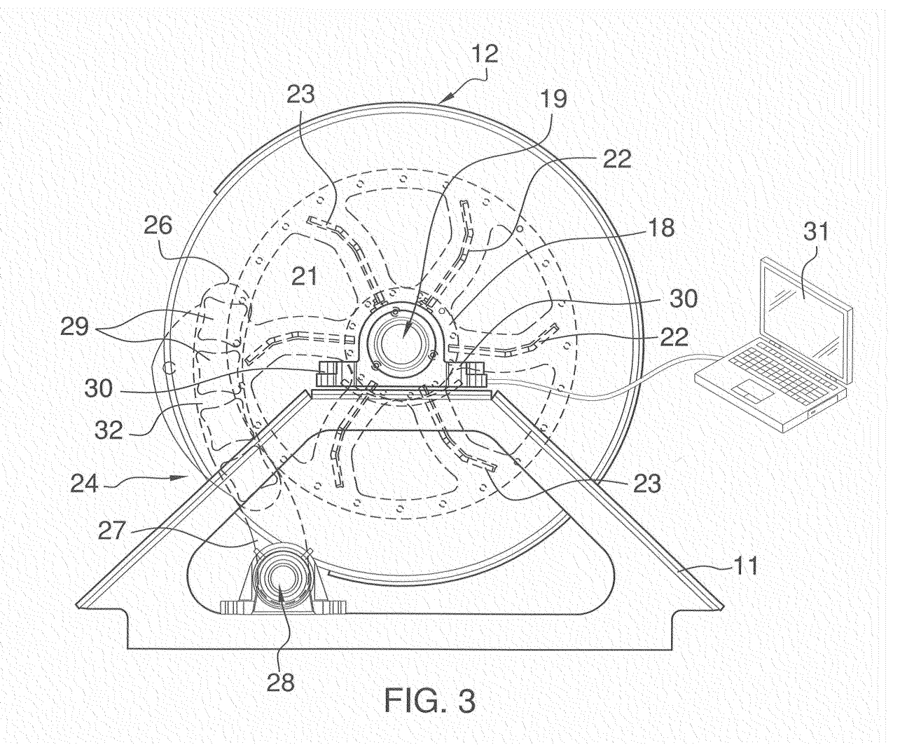

As illustrated in FIG. 3, each of the disc members 15 is made of a non-ferrous metal and has opposed planar sides 16, 17 and a huh 18 with a central opening 19 through which the drive shaft 14 is securely and conventionally attached or welded. The disc members 15 may he axially aligned with one another along a length of the drive shaft 14 with the planar sides 16, 17 of the disc member 15 being arranged parallel to one another. The air mover assembly 12 may further include blades 20 conventionally attached and welded to at least one of the opposed sides 16, 17 of each of the disc members 15 to form centrifugal fan units. The blades 20 may extend radially from the hubs 18 and along at least one of the opposed sides 16, 17 of each of the disc members 15 with each of the blades 20 having an proximate end portion 21, an intermediate portion 22 angled relative to the proximate end portion 21, and a distal end portion 23 angled relative to the proximate end 21 and intermediate portions 22. The blades 20 have fiat surfaces which lie in planes disposed perpendicular to the sides of the disc members 15 with longitudinal edges of the blades 20 securely and conventionally attached and welded to at least one of the opposed sides 16, 17 of each of the disc members 15. The power source 13 used to rotate the drive shaft 14 and the disc members 15 may be an internal combustion engine conventionally mounted to the base 11 and used to also generate usable beat when the fan units are actuated and patting a load on the internal combustion engine.

As shown in FIGS. 1 through 4, the heat generating assembly 24 may further include a rotatable support shaft 25 having ends journaled to the base. The elongate support members 26 may be in communication and pivotable with the support shaft 25 and are axially aligned and spaced along the length of the support shaft 25 with the planar sides 32, 33 of the elongate support members 26 being arranged parallel to one another. Each of the elongate support members 26 may have a proximate end portion 27 with an opening 28 disposed laterally therethrough and through which the support shaft 25 is securely and conventionally disposed or welded. The support shaft 25 has a longitudinal axis which may be disposed parallel to a longitudinal axis of the drive shaft 14. The elongate support members 26 adjacent to one another may be movably and adjustably positionable to either side of a respective one of the disc members 15 with the magnetic members 29 on each of the adjacent elongate support members 26 generating eddy currents which may be created by the magnetic fields in a space between the magnetic members 29 on the adjacent elongate support members 26 and through which the respective disc member 15 rotates. The magnetic members 29 on a particular elongate support member 26 may all have the same magnetic pole, either positive or negative and the magnetic members 29 on an adjacent elongate support member 26 may all have the same magnetic pole but opposite to the magnetic pole for the magnetic members 29 on the adjacent elongate support member 26. The opposite poles of the magnetic members 29 generate eddy currents from the magnetic fields and may generate heat between the magnetic members 29 on adjacent elongate support members 26.

The heat generating assembly 24 may further include an actuator 34 such as a hydraulic pump in communication with and conventionally connected to the support shaft 25 for pivoting the support shaft 25 and the elongate support members 26 and moving the magnetic members 29 relative to the respective disc members 26 as desired. The magnetic members 29 on the adjacent elongate support members 26 heat the respective disc members 15 when the magnetic members 29 are movably disposed to either side of the respective rotatable disc members 15 and with the respective disc members 15 rotatably disposed between and axially aligned with the magnetic members 29 on the elongate support members 26. The respective disc members 15 are not heated with the eddy currents when the magnetic members 29 on the adjacent elongate support members 26 are moved away from either side of and not in axial alignment with the respective disc members 15 and the respective disc members 15 are not disposed between the magnetic members 29 on the adjacent elongate support members 26.

The magnetic heat generation and transfer apparatus and method 10 may further include sensors 30 conventionally arranged proximate to the heat generating assembly 24 and in conventional communication with the drive shaft 14 to detect heat generation and rotational speed of the drive shaft 14, and may also include a central processing unit 31 in conventional communication with the sensors 30 and with the power source 13 and the actuator 34 to control the positioning of the magnetic members 29 relative to the disc members 15 and to control the rotational speed of the drive shaft 14.

In use, the magnetic members 29 are positioned relative to the disc members 15 using the actuator 34 and the central processing unit 31. To generate heat, the magnetic members 29 are moved in close proximity to the rotatable disc members 15 to create magnetic fields in spaces between adjacent elongate support members 26 with the eddy currents being created from the magnetic fields and heating the disc members 15 as the disc members 15 rotate through the magnetic fields. The elongate support members 26 adjacent to one another are pivoted by the support shaft 25 and are moved to opposite sides of the respective rotatable disc members 15 with the respective disc members 15 disposed between the magnetic members 29 on the adjacent elongate support members 26. The eddy currents generated by the opposite magnetic poles of the magnetic members 29 neat the respective disc members 15 as the disc members 15 rotate through the magnetic fields. The central processing unit 31 in cooperation with the sensors 30 controls the positioning of the magnetic members 29 in relationship to the disc members 15. The central processing unit 31 energizes the actuator 34 which pivots the support shaft 25 and the elongate support members 26 adjacent to one another. To control the heat and to cool the disc members 15, the central processing unit 31 actuates the support shaft 25 to pivot the elongate support members 26 and the magnetic members 29 away from opposite sides of the disc members 15 with the disc members 15 not disposed between the magnetic members 29 on the adjacent elongate support members 26.

The heat generated may be transferred and used with air moved by the fan units and with the air moved in relationship to the disc members 15 and the magnetic members 29. As controlled by the central processing unit 31, the disc members 15 and the blades 20 are actuated and rotated by the power source 13 thus causing air to flow about the disc members 15 and the magnetic members 29 to provide a flow of usable heat to and through directional units such as tubes or other ducts or conduits.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the pans of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the magnetic heat generation and transfer apparatus and method. Further, since numerous modifications and changes will readily occur to those skilled in the art, it is not desired to lima the invention to the exact construction and operation shown and described, and accordingly, all suitable modifications and equivalents may be resorted to, falling within the scope of the invention.

I claim:

1. A magnetic heat generation and transfer apparatus comprising:
a base:
an air mover assembly mounted to the base and including a power source with a rotatable drive shaft and also including disc members spaced apart and attached to the rotatable shaft for rotation therewith; and
a heat generating assembly mounted to the base and including pivotable elongate support members and magnetic members attached to the elongate support members for generating eddy currents resulting in heat generation.

2. The magnetic heat generation and transfer apparatus as described in claim 1, wherein each of the disc members is made of a non-ferrous metal and has opposed planar sides and a hub with a central opening through which the drive shaft is attached.

3. The magnetic heat generation and transfer apparatus as described in claim 2, wherein the disc members are axially aligned with one another along a length of the drive shaft, wherein the planar sides of the disc members are arranged parallel to one another.

4. The magnetic heat generation and transfer apparatus as described in claim 2, wherein the air mover assembly further includes blades attached to at least one of the opposed sides of each of the disc members to form fan units.

5. The magnetic heat generation and transfer apparatus as described in claim 4, wherein the blades extend radially from the hubs and along at least one of the opposed sides of each of the disc members with each of the blades having a proximate end portion, an intermediate portion angled relative to the proximate end portion, and a distal end portion angled relative to the proximate end and intermediate portions.

6. The magnetic heat generation and transfer apparatus as described in claim 4, wherein the blades have fiat surfaces which lie in planes disposed perpendicular to the planar sides of the disc members with longitudinal edges of the blades attached to at least one of the opposed sides of each of the disc members.

7. The magnetic heat generation and transfer assembly as described in claim 4, wherein the power source is an internal combustion engine mounted to the base and generating usable heat when the fan units are actuated and putting a load on the internal combustion engine.

8. The magnetic heat generation and transfer assembly as described in claim 1, wherein the heat generating assembly further includes a rotatable support shaft having ends journaled to the base, wherein the elongate support members are in communication and pivotable with the support shaft and are axially aligned along the length of the support shaft.

9. The magnetic heat generation and transfer assembly as described in claim 8, wherein each of the elongate support members has opposed planar sides and has a proximate end portion with an opening disposed laterally therethrough and through which the support shaft is securely disposed, wherein the planar sides of the elongate support members are arranged parallel to one another.

10. The magnetic heat generation and transfer assembly as described in claim 8, wherein the support shaft has a longitudinal axis which is disposed parallel to a longitudinal axis of the drive shaft.

11. The magnetic heat generation, and transfer assembly as described in claim 8, wherein the elongate support members adjacent to one another are movably and adjustably positionable to either side of a respective one of the rotatable disc members, wherein the magnetic members on one of the elongate support members has magnetic poles opposite to that of the magnetic members on the adjacent elongate support member thus generating magnetic fields and eddy currents in a space between the adjacent elongate support members and through which the respective disc member rotates and is heated, wherein the magnetic members are attached to and spaced upon the planar sides of and along a length of each of the elongate support members.

12. The magnetic heat generation and transfer assembly as described in claim 11, wherein the heat generating assembly further includes an actuator in communication with the support shaft for pivoting the support shaft and the elongate support members and moving the magnetic members relative to the respective disc members as desired.

13. The magnetic heat generation and transfer assembly as described in claim 12 further includes sensors proximate to the heat generating assembly and in communication with the drive shaft to detect heat generation and rotational speed of the drive shaft, and also includes a central, processing unit In communication with the sensors and with the power source and the actuator to control the positioning of the magnetic members relative to the disc members and to control the rotational speed of the drive shaft.

14. The magnetic heat generation and transfer assembly as described in claim 11, wherein the magnetic members on the adjacent elongate support members heat the respective disc members when the magnetic members are movably disposed to either side of and in axial alignment with the respective disc members and with the respective disc members disposed between the magnetic members on the elongate support members,

15. The magnetic heat generation and transfer assembly as described in claim 11, wherein the respective disc members are not heated by the eddy currents when the magnetic members on the adjacent elongate support members are moved away from, either side of the respective disc members and the respective disc members are not disposed between the magnetic members on the adjacent elongate support members.

16. A method of magnetic neat generation and transfer comprising the steps of:
providing rotatable disc members mounted to a drive shaft connected to an actuator and also providing blades attached to the disc members and forming fan units and further providing magnetic members on elongate support members attached to a pivotable support shaft;
positioning the magnetic members relative to the disc members; and
moving air in relationship to the disc members and the magnetic members.

17. The method of magnetic heat generation and transfer as described in claim 16, wherein the positioning the magnetic members includes moving the magnetic members in close proximity to the disc members to create magnetic fields and to effect eddy currents upon and heat the disc members rotating through the magnetic fields.

18. The method of magnetic heat generation and transfer as described in claim 17, wherein the moving the magnetic members also includes moving the elongate support members adjacent to one another to opposite sides of the respective disc members with the respective disc members rotatably disposed between the magnetic members on the adjacent elongate support members and being heated by the eddy currents effected by the magnetic fields created by the magnetic members.

19. The method of magnetic heat generation and transfer as described in claim 17, wherein the moving the magnetic members further includes moving the elongate support members adjacent to one another away from opposite sides of the respective disc members with the respective disc members disposed not between the magnetic members on the adjacent elongate support members to control the heat generation and to cool the respective disc members.

20. The method of magnetic heat generation and transfer as described in claim 16, wherein the moving air includes actuating the rotation of the disc members and the blades causing air to flow about the disc members and the magnetic members to provide a flow of usable heat to and through directional units.
